(19) United States
(12) Patent Application Publication
(10) Pub. No.: US 2021/0141385 A1
(43) Pub. Date: May 13, 2021

(54) METHOD AND SYSTEM FOR OPERATING AN AUTOMATIC DRIVING FUNCTION IN A VEHICLE

(71) Applicant: Volkswagen Aktiengesellschaft, Wolfsburg (DE)

(72) Inventors: Jörn Michaelis, Berlin (DE); Maximilian Barthel, Markkleeberg (DE)

(21) Appl. No.: 17/057,066

(22) PCT Filed: Jun. 4, 2019
(86) PCT No.: PCT/EP19/64395

§ 371 Date: Nov. 19, 2020

(30) Foreign Application Priority Data
Jun. 8, 2018 (DE) 10 2018 209 191.9

(51) Int. Cl. G05D 1/02; B60W 30/18; B60W 60/00

(52) U.S. Cl. CPC G05D 1/0231; G05D 1/0212; B60W 30/18145; B60W 30/18163; B60W 2720/12; G05D 2201/0213; B60W 2754/10; B60W 2720/10; B60W 60/001

(57) ABSTRACT

Technologies and techniques for operating an automatic driving function in a vehicle, in which surroundings data are detected and, based on the detected surroundings data, graphical data of a representation of the surroundings are generated and output. An automatic driving function is executed subject to a control signal generated from actuating a selection object. The selection object may be generated and assigned to a first operating object.

### RELATED APPLICATIONS

The present application claims priority to international Patent Application No. PCT/EP2019/064395 to Jörn Michaelis et al., titled “Method and System for Operating an Automatic Driving Function in a Vehicle”, filed Jun. 4, 2019, which claims priority to German Patent App. No. DE 102018209191.9 to Jörn Michaelis et al., filed Jun. 8, 2018, the contents of each being incorporated by reference in their entirety herein.

### BACKGROUND

The present disclosure relates to a method and a system for operating an automatic driving function in a vehicle.

It is increasingly the case in modern vehicles that single or complex sequences of driver tasks can be carried out to a large extent automatically, eventually reaching fully automatic driving along an intended route. The user of such a vehicle can manually influence the driving to a certain extent, in particular by inputting a target position, planning a route to the target, or through settings relating to specific automated driving functions. It should be noted that complex operating steps are necessary with existing systems to influence the driving or style of driving by the automatic system, e.g., an autopilot during partially or fully automated driving.

A driver assistance system is known from DE 10 2014 208 311 A1 in which the control of the vehicle is adapted to the individual preferences of the driver. There is a user profile with numerous parameters for this that are determined on the basis of the behavior of the user in a simulator or in a manual driving of a vehicle.

DE 10 2016 203 827 A1 proposes a method in which an instruction by an occupant of the vehicle is detected during an automatic drive, and a new route is determined on the basis of this instruction.

An aspect of the present disclosure is therefore to create a method and a system of the types described above, in which the user of a vehicle can quickly and easily influence and control the functioning of an automatic driving function.

### BRIEF SUMMARY

Environment data may be recorded in a vehicle environment according to the present disclosure, and graphic data for depicting an environment are generated and output based on the recorded environment data. This depiction of the environment may include at least one first operating object, wherein, if actuation of a first operating object is detected, a selection object is generated that is assigned to the first operating object. An actuation of the selection object is detected, and a control signal is generated on the basis of the actuation of the selection object, wherein the automatic driving function is carried out on the basis of the control signal.

As a result, a graphical user interface can be advantageously provided, by means of which a user can input desired settings and control instructions in a particularly simple, quick, and intuitive manner. This results in an ergonomically advantageous operation, because the relevant operating elements are placed such that they can be reached particularly easily. Intervention in an automatic driving function can also take place very quickly, because a direct actuation can be achieved via the operating object and the selection objection. This may increase the safety in operating the automatic driving function. This also may give the user greater trust in the automatic driving function because there are clear interaction possibilities, and the data in the system can be presented such that they can be readily understood. It may therefore be unnecessary to directly shut off an autopilot or similar driving function to allow the driver to intervene in the control. This depiction can also be visible, and potentially also accessible, to a passenger in the front of the vehicle, and/or other vehicle occupants, so that they are not surprised by fully automatic driving maneuvers.

The environment may be recorded in a known manner, in particular by means of sensors on the vehicle. These sensors may include, for example, optical, electromagnetic, acoustic, and/or other sensors. By way of example, a camera, stereo camera, 3D camera, infrared camera, lidar or radar sensors, or an ultrasonic sensor can be used. The environment data may include traffic-relevant regulating objects, such as other road users, traffic control elements and markings on a street, or other markings along a roadway. The recording of the environment data is adapted in particular to the automatic driving function, and is configured to provide the information necessary for carrying out the automatic driving function. Additionally or alternatively, the environment data can be recorded by means of an interface to an external device, such as a central recording device (e.g., a camera) for observing traffic, or an external service, e.g., an external server. The environment data may also include, positions, directions, and speeds of traffic-relevant objects in the vehicle's environment. In some examples, data regarding a driving state of the actual vehicle are also recorded, such as the position, speed, direction, or route on which the vehicle is currently traveling.

In some examples, the operating environment may include at least one graphic element, which represents information derived from the environment data. A first operating object detected in the environment depiction may be configured as a representation of the actual vehicle (ego vehicle). The first operating object may include a depiction of a vehicle, in particular. The environment depiction can also include a representation of traffic-relevant objects in the vehicle environment, in particular in a schematic illustration. This depiction may include other road users, such as vehicles or pedestrians, lane markings, and/or the course of a road. The first operating object represents, for example, an element in the traffic in the environment of the vehicle, such as the actual vehicle. As a result, the first operating object can be placed at a position within the environment depiction that corresponds to the position of the vehicle on the road, in a specific lane. The operating object is therefore not merely depicted as a simple geometric form or similar element in a static depiction, unrelated to the traffic situation in the vehicle environment.

The actuation of the first operating element can be detected in a known manner, e.g., through a selection of the first operating object within a graphical user interface by means of a touchscreen, touchpad, joystick, rotary push button, or steering column paddle. Other possibilities for actuation are also conceivable. By way of example, the environment depiction can comprise a first operating object depicted as a vehicle icon, and the actuation can take place by touching a touchscreen in the proximity of the operating object.

The selection object generated after actuating the operating object can be formed in a number of ways. It can, for example, take the form of a pop-up menu or context menu. It can include numerous selection possibilities, which may be depicted as individual buttons within the selection object. The selection object may include numerous selection options that are assigned to different driving maneuvers or different aspects or functionalities of the automatic driving function.

When the selection object is actuated, it is detected how the actuation takes place, e.g., which region of the selection object is actuated, and whether the actuation is assigned a specific selection option or functionality. When a control signal is generated on the basis of the actuation of the selection object, it is first determined how the actuation takes places, or an input parameter is detected with the actuation, and a corresponding control signal is subsequently generated. By way of example, the selection object may include a context menu, the actuation of which includes touching a touchscreen in the proximity of the context menu and a specific selection option. A control signal is generated on the basis of the actuation and sent to a device that controls the automatic driving function. The functioning of the automatic driving function can be influenced on the basis of the control signal, e.g. in that a specific maneuver is requested, or a specific manner of driving is selected. In doing so, a control command is generated for the automatic driving function on the basis of the control signal. The execution can take place immediately or after a delay, wherein the execution is delayed in particular until it can take place safely.

The environment depiction may also include a planning display with a graphical element that depicts a currently executed maneuver and/or a maneuver planned for the future. By way of example, a planned lane change or passing maneuver can be depicted by arrows, and a change in direction, in particular exiting a roadway, can also be depicted in a similar manner. A planning display can also include an anticipated behavior of another road user, e.g. when it has been detected that another vehicle is passing or intends to cut in front of the ego vehicle. The planning display can also include information regarding route planning, indicating a path to be taken, or a planned change in direction, in order to follow the planned route.

### BRIEF DESCRIPTION OF THE DRAWINGS

The present disclosure shall now be explained using exemplary embodiments, in reference to the drawings. Therein:

FIG. 1 shows a vehicle with an exemplary embodiment of the system according to an aspect of the present disclosure; and

FIGS. 2A, 2B, 2C show examples of environment depictions generated in an exemplary embodiment of the method according to an aspect of the present disclosure.

### DETAILED DESCRIPTION

In some examples, an environment depiction may be configured to represent an actual, or a predicted traffic situation in the vehicle environment. The ego vehicle may be generally located in the center of the environment depiction, and is represented by a graphic element, in particular the first operating object. By way of example, the environment depiction may include graphic objects that represent other road users, arranged corresponding to the actual situation in the vehicle environment, in particular in a schematic illustration. By way of example, it can be derived from the environment depiction whether another vehicle is located in front of the ego vehicle in the direction of travel, in particular the distance to the other vehicle can be depicted. Other vehicles or road users behind the ego vehicle, or in other lanes, can be indicated analogously, e.g. oncoming vehicles, or vehicles in a neighboring lane traveling in the same direction.

In some examples, a control signal may be generated on the basis of the actuation of a selection objection, which may relate to a lane change, turn, altering the distance to other road users, or altering the speed of the vehicle. As a result, particularly parameters of interest for automatic driving functions can be advantageously be modified. Other maneuvers can also be controlled, e.g. passing, driving to a specific target, e.g. the next rest area, or leaving the current road at the next exit. It is ensured thereby that the vehicle is always driven safely, and a predefined safety distance can be ensured. At the same time, a maneuver can be requested without having to reprogram the current route, terminating the automatic driving function, and/or manually intervening in the driving process.

These maneuvers or parameters for automatic control functions relate in particular to a road user represented by a first operating object, in particular an ego vehicle. As a result, the operation is directly related to the traffic situation, wherein the user may actuate the operating object assigned to his own vehicle, and can then set parameters for controlling precisely this vehicle.

In some examples, the environment depiction may include at least one further operating object, wherein, when an actuation of another operating object is detected, a further selection object is generated that is assigned to the other actuated operating object. An actuation of the other selection object is detected, and a control signal is generated on the basis of the actuation of the other selection object, wherein the automatic driving function is carried out on the basis of the control signal. As a result, various selection objects for controlling the automatic driving function can advantageously be provided and made available in a depiction containing operating objects in conjunction with other road users, for example.

Other operating objects may be configured to represent some other road user that the ego vehicle in particular. By way of example, the other operating object can be output within the environment depiction such that it is located in relation to the first operating object, corresponding to the ego vehicle, in a position corresponding to the actual traffic situation. In particular, the actual traffic situation can be simplified or abstracted, such that the depiction of the traffic-relevant environment is simplified. In particular, it can be derived from the locations of the first and second operating objects within the environment depiction, whether another road user is traveling behind, in front of, or next to the ego vehicle. The depiction can also indicate whether and to what extent another road user is approaching the ego vehicle, or moving away therefrom.

The other selection object includes, in particular, buttons for various maneuvers, wherein the selection options for the further selection object may be different than for the selection object assigned to the first operating object.

In one embodiment of the method, a control signal is generated on the basis of the actuation of the further selection object, which relates to a driving maneuver with respect to another road user. As a result, the automatic driving function can advantageously be controlled such that a driving maneuver can be carried out or supported on the basis of the other operating object, relating to a behavior of the ego vehicle with respect to other road users.

Such a driving maneuver with respect to another road user can be a passing maneuver, for example. It can also relate to driving next to or behind another vehicle. It may also be possible to establish a communication connection to the other road user, e.g. by means of a data-technology connection, by means of which a control signal and/or a message, in particular a text message or some other form of messaging, can be sent to another vehicle driver.

In another embodiment, the graphic data are sent to a user device and output by the user device, wherein the user device is assigned to a passenger in the vehicle. As a result, not only the vehicle driver, but also other occupants of the ego vehicle, and potentially other people, can access information in the environment depiction, as well as intervening in the control of the vehicle. There can also be a planning function with which numerous people can cooperatively plan or modify the driving of the vehicle using a user device.

The user device may be independent of the vehicle, such as via a cell phone, a tablet, or a portable computer. The user device can also be incorporated in the vehicle, such as a touchscreen integrated in the vehicle, either near the front passenger seat, or in the back, for rear seat passengers. The user device can be coupled to the vehicle in a variety of ways, in particular by means of a wireless data technology connection, or with a hardwire connection, in particular through a cradle integrated in the vehicle.

In some examples, the user device can be assigned to a user other than the passengers or occupants of the vehicle, e.g. an operator that can influence the driving of the vehicle via a data technology connection, and can potentially intervene therein.

In some examples, the user device may be identified, and the selection objects are generated on the basis of the identity. Alternatively or additionally, the user can also be identified. The information output by means of the user device can be controlled using different authorizations. Furthermore, the driving functions that can be controlled by means of the selection objects can be adapted to the different authorizations and roles of different users.

Specific information can be output, depending on which user device or user is identified. As a result, it can be ensured that a passenger or other occupant of the vehicle will not be surprised by an upcoming driving maneuver by the automatic driving function. Furthermore, the other users can influence the planning of the automatic driving maneuver, e.g. through a discussion in the vehicle. It may also be the case that certain control signals for the automatic driving function can be generated by occupants of the vehicle other than the driver, e.g. with regard to route planning or the general driving behavior.

There are a number of known identification processes that may be implemented, such as user profiles, passwords, biometric data, or physical objects (e.g. a vehicle key, or the physical identity of the user device). Alternatively or additionally, identification can be established using a proximity detection device for a touchscreen in the vehicle, with which the direction from which a hand accesses the touchscreen is detected, in particular from the front passenger seat or the driver's seat. Furthermore, an electromagnetic field can be coupled to a user, and the field decoupled by the user's finger can be used to identify the user.

Further information selection objects may be also detected in some examples, wherein the actuation of which results in an output relating to the state of the vehicle. As a result, information regarding the state of the vehicle and/or the automatic driving function can advantageously be made available.

If an information selection object is actuated, driving parameters can be output, e.g. the current speed, forward speed, a target in a route, an upcoming passing maneuver, a general setting for passing behavior, the next planned maneuver and change in direction, planned exits from the road, or other information.

In some examples, a parameter for setting the automatic driving function is detected, or a driving profile may be activated on the basis of the selected first or second selection object. In particular, this parameter may include a target speed or the extent of a defensive or aggressive driving manner. By this means, it is possible to control, for example, whether a higher (aggressive) or lower (defensive) lateral acceleration is to be obtained during a change in direction, e.g. for passing. The driving profile can also include numerous adjustment parameters, defined by the manufacturer of a vehicle, or a system, or defined by the user himself. As a result, the automatic driving function can advantageously be adjusted to the preferences of a user. The driving behavior dictated by the automatic driving function can be set particularly easily and quickly as a result.

In some examples, a driving profile is generated on the basis of data recorded during a manual drive by a user or during a simulated drive by the user. The driving profile can be formed such that it imitates the manual driving style of the user, at least with regard to one or more adjustment parameters. By way of example, an average speed can be determined that a user typically reaches in certain situations when driving manually. Furthermore, a passing maneuver can be determined and stored.

In some examples, the graphic data may also include at least one button, wherein a control signal may be generated when the button is actuated, wherein the automatic driving function is carried out on the basis of the control signal. In one configuration, there can be a speed-dial button for a specific maneuver or for setting a specific parameter or driving profile. As a result, certain operations can be performed particularly quickly.

Speed-dial buttons can be displayed, for example, in a region adjacent to the environment depiction. The speed-dial buttons can also be physical buttons. In particular, the buttons include a graphical depiction that symbolizes a specific driving maneuver.

In some examples, a system is disclosed for operating an automatic driving function in a vehicle that may include an environment recording device, by means of which environment data can be recorded in a vehicle's environment. The system may also include a control unit, by means of which graphic data can be generated using the recorded environment data for an environment depiction that contains at least one first operating object, and output by means of a display unit, and an input unit, by means of which an actuation of the first operating object can be detected. The control unit may be configured to generate a selection object assigned to the first operating object, when the actuation of the first operating object is detected. An actuation of the selection object is also detected, and a control signal is generated on the basis of the actuation of the selection object. The automatic driving function can thus be carried out on the basis of the control signal.

A system according to the present disclosure may be configured in particular to implement the method according to the present disclosure described herein. The system therefore has the same advantages as the method according to the present disclosure.

The actuation of the operating object and/or the selection object may be detected by means of a touchscreen, touchpad, joystick, or steering column paddle. Alternatively or additionally, the input unit may include a further device for detecting a user input or actuation.

A vehicle containing an exemplary embodiment of the system according to the present disclosure shall be explained in reference to FIG. 1.

The vehicle 1 includes a control unit 5. A touchscreen 2, an environment recording unit 6, a drive unit 7, and a steering unit 8 are coupled to the control unit 5. The environment recording unit 6 includes numerous different sensors in the exemplary embodiment, which can record environment data in a vehicle's environment. The sensors are not shown in detail herein, and include, for example, a camera and other optical sensors, radar, lidar, and ultrasonic sensors, and an interface to an external server, by means of which it is possible to communicate with an external service for providing data regarding the vehicle's environment recorded by other devices.

The touchscreen 2 includes a display unit 3 and an input unit 4. These are arranged successively in a known manner, such that a touch-sensitive surface of the input unit 4 is placed over the display unit 3, and touching specific points on the touch-sensitive surface can be assigned positions within a display on the display unit 3. A user device 10 is also coupled to the control unit 5. This coupling includes a data technology connection and is, in particular, releasable, or wireless. In particular, there can be a data technology wireless connection between the control unit 5 and the user device 10, established through known methods, e.g. WLAN, Bluetooth, or near-field communication (NFC). The user device 10 can also be hard-wired to the control unit 5, in particular by means of a port in the vehicle 1. The user device 10 is located in particular in the vehicle 1, wherein the location inside or outside the vehicle 1 can be detected by a location detection unit, in particular to ensure that the user device [0044] 10 is located within the vehicle. The user device 10 can be a cell phone, a tablet, a portable computer, or a smartwatch worn by the user.

In some examples, a method according to the present disclosure shall be explained in reference to FIG. 1. This is based on the above description of the exemplary embodiment of the system according to the present disclosure.

Using the sensors in the environment recording unit 6, environment data is recorded in a vehicle 1 environment. The environment data include information regarding other road users, the route, and other traffic-relevant elements, markings and objects. The environment data may include positions and speeds in particular of other road users in relation to the ego vehicle, as well as a position of the ego vehicle, in particular in relation to the route, e.g., a position on a specific lane, for example. This can also include data regarding the current driving situation for the vehicle 1, e.g. its speed, direction, or geographic location, recorded by means of sensors in the vehicle for monitoring the driving parameters and/or a location determining system (e.g. GPS).

Graphic data for an environment depiction are generated using the recorded environment data, and output by means of the display unit 3. Examples of environment depictions are shown in FIGS. 2A, 2B, and 2C.

In the example shown in FIG. 2A, the environment depiction includes a first operating object 21, which represents the ego vehicle 1. There is another vehicle in front of the ego vehicle 1, traveling in the same direction, which is represented in the environment depiction by another operating object 22. The environment depiction also includes another operating object 23, which represents a vehicle diagonally behind and to the left of the ego vehicle 1, and another operating object 24, which represents a vehicle diagonally in front of and to the right of the ego vehicle 1. These operating objects 21, 22, 23, 24 are shown as vehicle symbols.

The environment depiction also includes an arrow 26, which indicates a planned lane change by the ego vehicle 1 for executing a passing maneuver. The environment depiction also includes road markings 25, in particular solid lines marking the region on the roadway that can be driven on, and broken lines that indicate individual lane boundaries. The display also includes buttons 27 with symbols representing the various user inputs. These are: calling up a navigation function and/or a function for activating an automatic driving function for a specific route, inputting a driving maneuver, and selecting a driving profile.

The environment depiction is output in a display window 30 in the display shown in FIG. 2A, wherein the display also includes other display windows 31 and display objects 32. The display windows 30, 31 form regions in the display area of the display unit 3 in the known manner, and are assigned to different applications. The display window 30 for the environment depiction and outputs in conjunction with an automatic driving function in the vehicle 1 takes up about half of the available display area in the exemplary embodiment in this example. The other display windows 31 relate to outputs from a media playback and a messenger for displaying and managing text messages. The display windows 30, 31 take other, known forms, and relate to other applications. The display objects 32 include a display of the current time, and an icon for outputting messages for the automatic driving function in these examples. In the case depicted herein, a steering wheel represents an automatic control of the vehicle 1, and a curved arrow represents an upcoming passing maneuver.

In the case shown in FIG. 2B, a user has touched the touchscreen 2 in the proximity of the first operating object 21, i.e. the symbol for the ego vehicle 1, and a selection object 36 is generated, which takes the shape of an arrow next to the first operating object, such that the assignment of the selection object 36 to the first operating object 21 is indicated visually. The selection object 36 includes three selection options 33, 34, 35. A first selection option 33 includes the text, “next rest area,” and an arrow, the next selection option 34 includes the text, “speed,” and the third selection option includes the text, “distance.”

In other exemplary embodiments, the selection object 36 can include other selection options 33, 34, 35, which include, in particular, driving maneuvers and settings for the automatic driving functions relating to the ego vehicle 1.

By actuating a selection option 33, 34, 35, i.e. by touching the touchscreen 2 in the proximity of one of the selection options 33, 34, 35, a user can activate the automatic control of the vehicle 1 such that a specific driving maneuver is carried out, or a specific adjustment can be made. As such, when the selection option 33, “next rest area,” is selected, the next opportunity to leave the route and enter a rest area is searched for, and the vehicle is driven to this rest area. After actuating the selection option 34, “speed,” another operating object is generated (not shown in the drawing), based on which the user can enter a new speed, or in which the user can adjust the automatic driving function, resulting in a faster or slower target speed for the automatic driving function. When the selection option 35, “distance,” is actuated, an input option is shown, similar to that for speed described above, in which the intended distance to other road users, in particular in front of the ego vehicle, can be adjusted, such that the automatic driving function ensures that the ego vehicle maintains a certain safety distance. Other driving maneuvers and adjustment parameters can also be, additionally or alternatively, included in the selection object 36.

The display can also include information selection objects, which, when actuated, result in a display of specific information regarding the state of the vehicle or the current driving situation, as well as planned driving maneuvers or adjustments or modalities of the currently executed automatic driving function. The information is output in this case in a known manner, in particular by means of a window generated in the display window 30. Alternatively or additionally, the information can be output in another display window 31.

In the example shown in FIG. 2C, the user has actuated the other operating object 22, which represents another vehicle in front of the ego vehicle 1. Another selection object 37 appears, which is assigned to the other operating object 22 by its location and an arrow. This other selection object includes a selection option labeled “passing,” and an arrow, as well as another selection option 38 containing the text, “message to.” The selection options 38, 39 included by the other selection object 37 include automatic driving functions, other functionalities and adjustment parameters for the automatic driving function, which relate to a behavior of the ego vehicle 1 in relation to other vehicles, in this case the relationship to the leading vehicle. Other selection options can therefore be included in this, or a comparable, area.

If the user actuates the touchscreen 2 in the proximity of the selection option 38 (“passing”), a passing maneuver is initiated by the automatic driving function. A control signal is stored for this, for example, in a memory for the automatic driving function, which results in executing the passing maneuver when it is safe to do so. This ensures that the vehicle 1 is driven safely. If the user actuates the touchscreen 2 in the proximity of the other selection option 39 (“message to”), an input option is shown, by means of which the user can send a message to the leading vehicle, or to its driver, in particular a text message. Such a message can be input by means of a keyboard, by means of speech input, by selecting a previously composed message, or in some other known manner.

In the exemplary embodiment, the output takes place by means of the touchscreen 2 in the vehicle 1, which is located in the center console, such that the driver of the vehicle 1 can operate it. In another exemplary embodiment, the touchscreen 2 contains a proximity detection element, which is configured to determine the direction from which a user approaches the touchscreen. This can be implemented, e.g., by means of a camera or a capacitive or optical proximity detection element. The user is identified by this means, in that it is determined if the touchscreen has been approached from the driver's seat or the passenger seat.

Different users may be configured to have different authorizations, wherein the driver of the vehicle 1 can intervene in the active functions of the automatic driving function, to trigger specific driving maneuvers, or to adjust a speed or distance in relation to other road users. If it has been detected that the passenger is operating the touchscreen, the passenger is unable to select the corresponding selection options, as can be indicated in the known manner by a modified display, such as a corresponding symbol, a shaded or at least translucent display, or in some other manner.

The display can also be modified such that information relevant to the passenger regarding the current travel, and in particular regarding functions of the automatic driving function, are output, e.g. planned maneuvers, a currently set target speed, or a currently set distance to other vehicles. Information regarding the route, as well as any options for modifying the planned route, can also be displayed, the authorizations for which can be altered. By way of example, a driver or user having special authorization can give authorization to other users for individual functionalities, such as a cooperative route planning.

In another example, the display is sent to a user device 10 and displayed thereon, wherein the user device and/or the user to which this user device 10 is assigned, are also identified. The user device 10, or its user, can be assigned different authorizations, which determine which functionalities can be accessed, which information can be viewed, and which functionalities can be controlled. The depiction and provision of operating options can be adapted to the user device 10 in a similar manner to that described above with regard to the passenger.

In particular, there can be numerous user devices 10. In one exemplary embodiment, the system includes the touchscreen 2 in the middle console in the vehicle 1 as well as other user devices 10, which can be touchscreens integrated in the vehicle for the front passenger seat or the rear passenger seats, as well as mobile devices carried by the users, in particular those located in the vehicle 1. With an appropriate assignment of the authorizations to various users and user devices 10, it can be ensured that information relevant to individual vehicle occupants can be called up, and collective control tasks for an automatic driving function can be carried out.

### LIST OF REFERENCE SYMBOLS

1 vehicle
2 touchscreen
3 display unit
4 input unit
5 control unit
6 environment recording unit
7 drive unit
8 steering unit
10 user device
21 first operating object; vehicle symbol “ego vehicle”
22 other operating object; vehicle symbol “leading vehicle”
23 other operating object; vehicle symbol “other vehicle, diagonally behind”
24 other operating object; vehicle symbol “other vehicle, diagonally behind”
25 road marking
26 arrow
27 button
30 display window
31 other display window
32 display object
33 selection option “next rest area”
34 selection option “speed”
35 selection option “distance”
36 selection object
37 other selection object
38 selection option “passing”
39 selection option “message to”

1-10. (canceled)

11. A method for operating an autonomous driving function in a vehicle, comprising:
recording environment data in the vehicle;
generating and outputting graphic data, based on the recorded environment data, wherein the graphic data comprises an environment depiction comprising at least one first operating object;
detecting an actuation of the first operating object;
generating a selection object and assigning the selection object to the first operating object;
detecting an actuation of the selection object; and
generating a control signal in response to the actuation of the selection object, wherein the automatic driving function is executed out based on the control signal.

12. The method according to claim 11, wherein the selection object comprises one of a lane change, turning, altering a distance to other road users, or modifying the speed of the vehicle.

13. The method according to claim 11, wherein the environment depiction comprises at least one further operating object, wherein, if an actuation of another operating object is detected, another selection object is generated and assigned to the actuated, other operating object.

14. The method of claim 13, further comprising detecting an actuation of the other selection object, and generating another control signal, based on the actuation of the other selection object, wherein the automatic driving function is carried out on the basis of another control signal.

15. The method according to claim 13, further comprising generating a control signal on the basis of the actuation of another selection object relating to a driving maneuver for another road user.

16. The method according to claim 13, further comprising recording an adjustment parameter for the automatic driving function on the basis of one of (i) an actuation of the selection object or (ii) an actuation of the another selection object, or (iii) the activation of a driving profile.

17. The method according to claim 11, further comprising transmitting the graphic data to a user device for output, wherein the user device is assigned to a passenger in the vehicle.

18. The method according to claim 17, wherein the selection objects are generated on the basis of the identification of the passenger.

19. The method according to claim 18, wherein the selection objects comprise other information selection objects, in which a state of the vehicle is output when the other information selection objects are actuated.

20. The method according to claim 11, wherein the graphic data comprises at least one button, wherein the control signal is generated when the button is actuated.

21. A system for operating an automatic driving function in a vehicle, comprising:
an environment recording unit for recording environment data in the vehicle;
a control unit for generating graphic data for an environment depiction comprising at least one first operating object, using the recorded environment data; and
an input unit, for detecting actuation of the first operating object,
wherein the control unit is configured such that, when the actuation of the first operating object is detected:
a selection object is generated, which is assigned to the first operating object;
an actuation of the selection object is detected; and
a control signal is generated on the basis of the actuation of the selection object, wherein the automatic driving function is activated on the basis of the control signal.

22. The system according to claim 21, wherein the selection object comprises one of a lane change, turning, altering a distance to other road users, or modifying the speed of the vehicle.

23. The system according to claim 21, wherein the environment depiction comprises at least one further operating object, wherein, if an actuation of another operating object is detected, another selection object is generated and assigned to the actuated, other operating object.

24. The system of claim 23, wherein the control unit is configured to detect an actuation of the other selection object, and generating another control signal, based on the actuation of the other selection object, wherein the automatic driving function is carried out on the basis of another control signal.

25. The system according to claim 23, wherein the control unit is configured to generate a control signal on the basis of the actuation of another selection object relating to a driving maneuver for another road user.

26. The system according to claim 23, wherein the control unit is configured to record an adjustment parameter for the automatic driving function on the basis of one of (i) an actuation of the selection object or (ii) an actuation of the another selection object, or (iii) the activation of a driving profile.

27. The system according to claim 21, wherein the control unit is configured to transmit the graphic data to a user device for output, wherein the user device is assigned to a passenger in the vehicle.

28. The system according to claim 27, wherein the selection objects are generated on the basis of the identification of the passenger.

29. The system according to claim 28, wherein the selection objects comprise other information selection objects, in which a state of the vehicle is output when the other information selection objects are actuated.
